(19) United States
(12) Patent Application Publication
(10) Pub. No.: US 2006/0161451 A1
(43) Pub. Date: Jul. 20, 2006

(54) Method for protecting the privacy of phone numbers entered by internet consumers by forwarding calls through intermediary phone numbers

(76) Inventors: John Sung Kim, Dublin, CA (US); Maad Abu-Ghazalah, Pacifica, CA (US)

Correspondence Address: Maad Abu-Ghazalah, P.O. Box 1219, Pacifica, CA, 94044, US

(21) Appl. No.: 11/336,561

(22) Filed: Jan. 19, 2006

Related U.S. Application Data
(60) Provisional application No. 60/645,086, filed on Jan. 19, 2005.

(51) Int. Cl. G06Q 99/00; G06Q 30/00

(52) U.S. Cl. 705/1; 705/26

(57) ABSTRACT

A method is presented for protecting the privacy of phone numbers entered by consumers on the internet by using a third party to assign intermediary phone numbers which can be used by online vendors to make calls that are forwarded to the consumers' actual phone numbers, thereby masking the online vendors from knowledge of the consumers' actual phone numbers.

We claim priority to: Provisional Application No. 60/645,086 filed on Jan. 19, 2005.

### BACKGROUND OF THE INVENTION

1. Field of the Invention

The present invention relates to an improved data processing system, and, in particular, to a business practice.

2. Description of Related Art

Most vendors include a privacy clause when asking for contact information. But, in spite of this, contact information provided to vendors often gets sold to third parties or is used in other ways the information provider would not approve. This has made people very wary of providing their contact information. The issue of the privacy of contact information has become such a significant problem that Congress has gone to the extent of passing a law making it illegal to call individuals who put themselves on a “no call” list.

This has also created a problem for online vendors since many consumers may visit their site and are interested in purchasing the vendor's product or service but are not willing to provide their contact information for fear that it will be distributed inappropriately. Vendors lose potential sales simply because they have no way to contact visitors to their site who are too concerned about the privacy of their contact information, and simply leave the vendor's site without releasing their phone number and other contact information.

With the wide availability of free internet-based email services, people have been able to solve the privacy issue regarding their e-mail by creating special e-mail accounts for specialized contact purposes. For example, a person can very quickly and easily create a special e-mail account when buying a house in order to have financial institutions provide information. Once the person has bought the house, he or she can simply discontinue using that e-mail account. What the financial institutions do with that person's e-mail after that will not impact his or her privacy.

Unfortunately, this same mechanism cannot be used to protect an individual's phone number. Obtaining a phone number for specialized purposes is not practical. Establishing a new phone line can be expensive and time-consuming and it is not economically practical to establish a new phone line whenever a person wants to distribute his or her contact information. Constantly changing one's existing phone number after the specialized purpose has been completed is not practical either, since the person would have to contact all his or her friends and other associates to provide them the new phone number. When an online vendor requires a consumer to provide a phone number to receive further information, the consumer is left with little choice but to either provide his or her personal phone number or forego getting the information.

### SUMMARY OF THE INVENTION

A method is presented for protecting the privacy of phone numbers entered by consumers on the internet by using a third party to assign intermediary phone numbers which can be used by vendors to make calls that are forwarded to the consumers' actual phone numbers.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1 is a flow chart depicting the process through which an online vendor re-directs consumers to a third party to enter contact information.

FIG. 2 is a flow chart depicting the process through which a third party generates an IPN and uses it to forward calls to an APN.

### DETAILED DESCRIPTION OF THE INVENTION

In order to protect themselves from liability for violating the privacy rights of visitors to their website, online vendors can utilize the services of a third party to generate intermediary phone numbers (IPN's). Visitors to the vendor's website provide their actual phone number (APN) to the third party which generates an IPN and provides the IPN to the vendor. The third party then forwards all calls from the vendor to the IPN to the website visitor's APN. This protects the privacy of the APN owner and masks the vendor from the APN thereby protecting the vendor from liability for violation of the APN owner's privacy rights. The origination and/or termination of the call can be delivered via Public Switched Telephone Network (PSTN), wireless cellular, or voice over internet protocol (VoIP)), without the vendor or website visitor knowing the other party's APN. Furthermore, if the website visitor no longer wishes to be contacted, he or she simply requests that the third party discontinue the IPN.

This provides website visitors with more confidence to enter their contact information when requested by websites, since they are assured that the privacy of their APN will be protected. For online vendors, this will improve the click through rate of visitors to their website, since visitors will not leave the site simply because they are unwilling to provide their contact information for fear it will be distributed inappropriately.

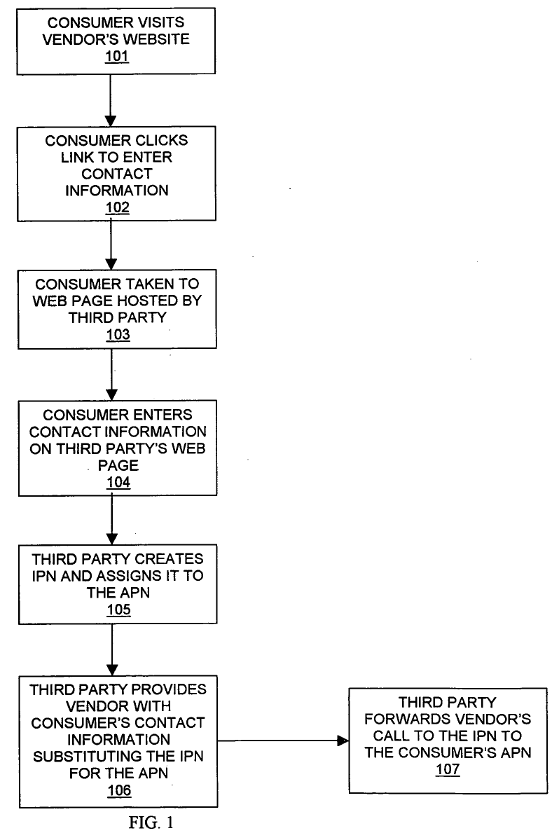

With reference to FIG. 1, a flow chart depicts the process through which an online vendor re-directs consumers to a third party to enter contact information in order to be protected from liability for violation of the consumer's privacy rights. First, a consumer visits the vendor's website (step 101). If the consumer wishes to be contacted by the vendor (e.g. for more information), the consumer clicks on a link on the vendor's website in order to provide his or her contact information (step 102). The consumer is then taken to a web page hosted by a third party (step 103). The consumer then enters his or her contact information on the third party's web page (step 104). If the contact information contains and APN, the third party then creates an IPN and assigns it to the consumer's APN (step 105). The third party then provides the consumer's contact information directly to the vendor, substituting the IPN for the consumer's APN if one exists (step 106). When the vendor calls the IPN, the third party forwards the call to the consumer's APN to which the IPN was assigned (step 107).

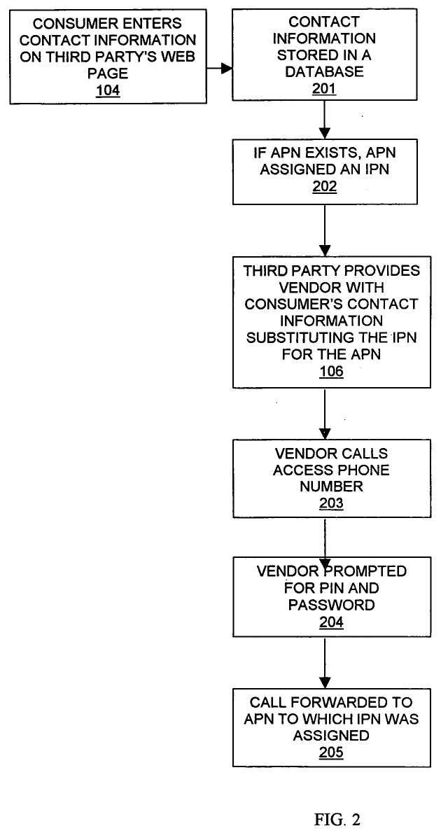

Referring now to FIG. 2, a flow chart depicts the process through which a third party generates an IPN and uses it to forward calls to an APN. First, the consumer enters his or her contact information on a web page hosted by the third party (step 104). The contact information is stored in a database (step 201). If the contact information contains an APN, the APN is automatically assigned an access phone number, personal identification number (PIN) and password (step 202). This access phone number, PIN and password constitute the IPN. The third party then directly provides the vendor with the consumer's contact information, substituting the IPN for the consumer's APN.

When the vendor calls the access phone number (step 203), he or she is prompted to enter the PIN and password (step 204). An Interactive Voice Response System (IVRS) is used to process the calls, including prompting the caller for a response. IVRS are commonly used in the telephony industry. The call is then automatically forwarded to the APN to which the IPN was assigned, based on PIN and password entered by the vendor (step 205).

In one embodiment, the IPN can be cancelled by the owner of the APN at any time. In another embodiment, the IPN expires after a specified time period.

In another embodiment, the third party charges the vendor a fee for each call forwarded to the APN. This would have the effect of limiting the number of unwanted phone calls to the APN by making mass “spams” prohibitively expensive.

This process protects the vendor from liability for violation of the website visitors' privacy through improper use or distribution of the APN since the vendor would be masked from any knowledge of the APN. Furthermore, the owner of the APN can protect his or her privacy at any time by instructing the third party to cancel the IPN which would discontinue the forwarding of calls to the APN.

A method for protecting the privacy of phone numbers, the computer implemented method comprising:

1. A method for protecting the privacy of the phone number of an online consumer comprising the following steps:
A. An online vendor linking the consumer to a web page hosted by a third party to acquire contact information from the consumer.
B. The consumer entering his or her contact information on the third party's web page.
C. The third party assigning an intermediary phone number (IPN) comprising an access phone number, Personal Identification Number and password to the actual phone number (APN) if it exists in the contact information.
D. The third party providing the consumer's contact information directly to the online vendor, substituting the IPN for the APN if one exists in the contact information.
E. The third party forwarding calls made to the IPN to the consumer's APN to which it was assigned.

2. A method for protecting the privacy of the phone number of an online consumer as in claim 1 further comprising the step of providing the consumer the ability to cancel the IPN on request.

3. A method for protecting the privacy of the phone number of an online consumer as in claim 1 further comprising the step of automatically canceling the IPN after a specified time.

4. A method for protecting the privacy of the phone number of an online consumer as in claim 1 further comprising the step of charging the party calling the IPN a fee to forward their call to the APN.
